(19) United States
(12) Patent Application Publication
(10) Pub. No.: US 2011/0151212 A1
(43) Pub. Date: Jun. 23, 2011

(54) METHOD FOR MAKING DEVICE HOUSING, AND DEVICE HOUSING

(75) Inventors: YUE-PING LIU, Shenzhen City (CN); HSIANG-JUNG SU, Shindian (TW); WEN-TE LAI, Shindian (TW)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/862,848

(22) Filed: Aug. 25, 2010

(30) Foreign Application Priority Data
Dec. 18, 2009 (CN) 200910311852.1

(51) Int. Cl. B32B 3/10; B32B 15/04

(52) U.S. Cl. 428/209; 428/195.1; 427/256; 427/261

(57) ABSTRACT

An exemplary method for making a device housing includes the following steps. Providing a substrate, and then forming a decorative coating on the substrate by paint jet printing. A device housing made by the method includes a substrate and a decorative coating formed on the substrate.

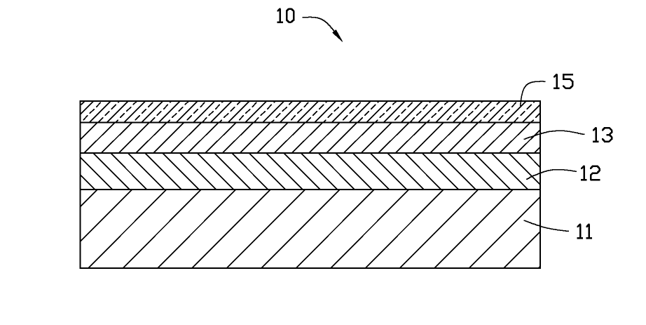

### BACKGROUND

1. Technical Field

The present disclosure relates to methods for making device housings, and to device housings.

2. Description of Related Art

Decorative coatings are widely used on housings of electronic devices (such as mobile phones and personal digital assistants). The decorative coatings may be formed, for example, by spray painting, electro deposition, vacuum deposition, or anodizing. However, these kinds of coatings are commonly monochromatic and difficult to present with patterned appearances. If a multi-colored and/or patterned appearance is desired, various masking processes must be applied during the process of forming the decorative coatings. As such, the cost of producing the electronic devices increases.

Therefore, there is room for improvement within the art.

### BRIEF DESCRIPTION OF THE DRAWING

Many aspects of the device housing may be better understood with reference to the following drawing. The components in the drawing are not necessarily drawn to scale, the emphasis instead being placed upon clearly illustrating the principles of the present method and device housing.

The drawing is a schematic, cross-sectional view of an exemplary embodiment of a device housing, showing a part of the device housing.

### DETAILED DESCRIPTION

A method for manufacturing a device housing may include the following steps: providing a substrate; and forming a decorative coating on the substrate by paint jet printing. As used herein, decorative means either or both of patterned or multi-colored.

Referring to the drawing, in an exemplary embodiment, a device housing 10 may be manufactured by the method as summarized above and more specifically described below.

A substrate 11 is provided. The substrate 11 may be made of plastic or metal.

A decorative coating 13 is formed on one surface of the substrate 11 using a paint jet printer (not shown). The decorative coating 13 may be an ultraviolet (UV) curable paint coating. The thickness of the decorative coating 13 may be about 8-10 micrometers (μm).

The paint jet printer may include a paint-box and a printing plate. The paint-box includes grids, and each of the grids can be filled with different color UV curable paint for forming the decorative coating 13. The UV curable paint may have a viscosity of about 8.0-8.5 pascal.second (Pa.s). A computer (not shown) installed with a design software may be electronically connected with the paint jet printer. The design software is used to design patterns and/or colors of the decorative coating 13 and control the paint jet printer to coat according to the patterns. The paint jet printer can precisely paint different colors and patterns next to each other on a substrate without intermediate masking steps. During the printing process, the substrate 11 is positioned on the printing plate, and then the computer executes commands to operate the paint jet printer to print a predefined pattern and/or colors on the surface of the substrate 11 to form the decorative coating 13. The decorative coating 13 is then heated in an oven to be solidified. Thus, the decorative coating 13 can be easily produced without the need for any masking steps.

A transparent protective coating 15 may be coated over the decorative coating 13 for protecting the decorative coating 13 from abrasion. The protective coating 15 may be formed by spraying transparent UV curable paint.

It is to be understood that a base paint coating 12 can be sprayed on the substrate 11 before forming the decorative coating 13. The base paint coating 12 may be used as a transition coating to facilitate adherence of subsequent coatings 13-15 more firmly attaching to the substrate 11.

It is to be understood that the device housing 10 according to the exemplary method includes the substrate 11, and the base paint coating 12, the decorative coating 13, the protective coating 15 formed on the substrate 11 in that order. In this embodiment, the decorative coating 13 is a colorful UV curable paint coating that has some kind of patterned or multi-colored appearance.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A method for making a device housing, the method comprising:
providing a substrate; and
forming a decorative coating on the substrate by paint jet printing.

2. The method as claimed in claim 1, wherein the substrate is made of plastic or metal.

3. The method as claimed in claim 1, wherein forming the decorative coating is carried out by a paint jet printer.

4. The method as claimed in claim 3, wherein forming the decorative coating is carried out by using ultraviolet curable paint.

5. The method as claimed in claim 4, wherein the ultraviolet curable paint has a viscosity of about 8.0-8.5 pascal.second.

6. The method as claimed in claim 1, further comprising coating a base paint coating on the substrate before forming the decorative coating.

7. The method as claimed in claim 1, further comprising forming a protective coating over the decorative coating.

8. The method as claimed in claim 7, wherein the protective coating is a transparent paint coating formed by spraying ultraviolet curable paint.

9. A device housing, comprising:
a substrate; and
a decorative coating formed on the substrate by paint jet printing, the decorative coating being a paint coating.

10. The device housing as claimed in claim 9, wherein the substrate is made of plastic or metal.

11. The device housing as claimed in claim 9, wherein the decorative coating defines a pattern on the surface of the substrate.

12. The device housing as claimed in claim 11, wherein colored paints are used to form the decorative coating.

13. The device housing as claimed in claim 9, wherein the decorative coating is an ultraviolet curable paint coating.

14. The device housing as claimed in claim 9, wherein the decorative coating has a thickness of about 8-10 micrometers.

15. The device housing as claimed in claim 9, further comprising a base paint coating formed between the substrate and the decorative coating.

16. The device housing as claimed in claim 9, further comprising a protective coating formed on the decorative coating.

17. The device housing as claimed in claim 16, wherein the protective coating is a transparent paint coating.

18. A method for making a device housing, the method comprising:
providing a substrate; and
forming a decorative coating on the substrate by paint jet printing using a paint jet printer, the decorative coating being a paint coating defining a pattern on a surface of the substrate.
